(19) United States
(12) Patent Application Publication
(10) Pub. No.: US 2022/0367856 A1
(43) Pub. Date: Nov. 17, 2022

(54) POSITIVE ELECTRODE ACTIVE MATERIAL FOR LITHIUM SECONDARY BATTERY

(71) Applicant: L&F CO., LTD., Daegu (KR)

(72) Inventors: Joo Hyeong WOO, Busan (KR); Sung Kyun CHANG, Daegu (KR); Sang Hoon JEON, Daegu (KR); Chang Min CHOI, Daegu (KR); Sung Woo CHO, Daegu (KR); Ji Sun AN, Daegu (KR)

(21) Appl. No.: 17/620,190

(22) PCT Filed: Jun. 15, 2020
(86) PCT No.: PCT/KR2020/007681

§ 371 Date: Apr. 29, 2022

(30) Foreign Application Priority Data
Jun. 17, 2019 (KR) 10-2019-0071243

(51) Int. Cl. H01M 4/36; H01M 4/04; H01M 4/525; H01M 4/505

(52) U.S. Cl. CPC H01M 4/366; H01M 4/0471; H01M 4/525; H01M 4/505; H01M 2004/021

(57) ABSTRACT

Disclosed is a cathode active material for a lithium secondary battery including a core containing lithium composite metal oxide and a coating layer disposed on the core and having an amorphous phase, wherein the amorphous phase contains lithium oxide and tungsten oxide in a form of mixture.

### TECHNICAL FIELD

The present invention relates to a cathode active material for a lithium secondary battery including a core containing lithium composite metal oxide and a coating layer disposed on the core, wherein the coating layer includes an amorphous phase containing lithium oxide and tungsten oxide in a form of mixture.

### BACKGROUND ART

Lithium secondary batteries are used in various fields, such as those of mobile devices, energy storage systems and electric vehicles, due to their high energy density and voltage, long cycle life, and low self-discharge rate.

Furthermore, lithium secondary batteries are required to exhibit various characteristics depending on the usage environment of the devices or appliances to which they are applied, and in particular are required to exhibit sufficient output characteristics at low temperatures when mounted in devices or appliances used in environments subject to great temperature changes, or in cold areas.

Accordingly, there are examples of coating materials of cathode active materials using tungsten in order to improve the low-temperature characteristics thereof. However, conventional tungsten-containing coating layers used for cathode active materials take the form of LiₓW_{y}O_{z}, which is a crystalline compound of lithium, tungsten, and oxygen. For this reason, the cathode active materials are problematic because they are not coated on the core in a crystallized state, but are separately present on the outside of the core, or are not uniformly coated on the surface thereof.

Examples of the related art will be described in more detail. First, Korean Patent Application Laid-Open Publication No. 10-2016-0050835 discloses a technology including diluting an acidic raw material (H₄WO₄) in a solvent and adding a core material to the resulting solution, followed by mixing and heat treatment. The technology includes precipitating lithium remaining on the surface during dilution in the solvent to induce a chemical reaction between the lithium and the tungsten raw material. The technology aims at coating the surface of the core material with a LiOH—Li₂CO₃—LiₓWO_{3-y} crystal (monoclinic, etc.).

Japanese Patent Application Laid-Open Publication No. 2013-152866 discloses a technology including adding an ammonium metatungstate solution to a core material, stirring the resulting mixture with a mixer and then heat-treating the mixture, and then precipitating lithium on the surface of the core material to form a lithium tungsten oxide, that is, a compound in the form of LiₓW_{y}O_{z}, on the surface of the core material, similar to the technique described above.

In addition, Japanese Patent Application Laid-Open Publication Nos. 2013-125732 and 2016-110999 disclose a technology including adding WO₃ to a solution of lithium hydroxide to obtain an aqueous alkali solution containing tungsten and lithium, adding a core material thereto and stirring the resulting mixture to form LiₓW_{y}O_{z}.

Accordingly, in the related art described above, lithium tungsten oxide is formed or coated as a crystallized phase rather than an amorphous phase on the surface of the core material by precipitating lithium remaining on the surface of the core material and inducing a chemical reaction between the lithium and a tungsten raw material.

In another example, Japanese Patent Application Laid-Open Publication No. 2013-125732 discloses a method of heat-treating a mixture of ammonium para-tungstate ((NH₄)₁₀W₁₂O₄₁.5H₂O) and a core material obtained by mixing in a mortar at 700° C. in the presence of an oxygen stream. During heat treatment, a material is formed in a crystalline phase rather than an amorphous phase on the surface.

In another approach, Korean Patent Application Laid-Open Publication No. 2013-0140194 discloses a method of directly spraying an element intended to be present on the surface of the core onto the surface thereof using a plasma or ion-sputtering method. However, this method is problematic in that the element is merely dotted on the surface of the core rather than being coated thereon in a uniform and wide area.

It is difficult for the lithium secondary batteries manufactured using the cathode active materials obtained in the prior art described above to exhibit low-temperature characteristics meeting a desired level due to the characteristics of the coating layer applied to the surface of the core. Thus, there is increasing need for the development of cathode active materials capable of solving these problems.

### PRIOR ART

### Patent Literature

Korean Patent Application Laid-Open Publication No. 2016-0050835
Japanese Patent Application Laid-Open Publication No. 2013-152866
Japanese Patent Application Laid-Open Publication No. 2013-125732
Japanese Patent Application Laid-Open Publication No. 2016-110999
Korean Patent Application Laid-Open Publication No. 2013-0140194

### DISCLOSURE

### Technical Problem

Therefore, the present invention has been made to solve the above and other technical problems that have yet to be resolved.

Therefore, as a result of extensive research and various experimentation, the present inventors have developed a novel cathode active material including a coating layer having an amorphous phase, and found that, since the cathode active material includes an amorphous phase containing lithium oxide and tungsten oxide in a form of mixture, a decrease in binding force to the core can be prevented, uniform coating can be realized, and the discharge capacity, output characteristics, and cycle characteristics of a lithium secondary battery, particularly the low-temperature characteristics thereof, can be remarkably improved. Based on this finding, the present invention has been completed.

### Technical Solution

In accordance with one aspect of the present invention, provided is a cathode active material for a lithium secondary battery including a core containing lithium composite metal oxide and a coating layer disposed on the core and having an amorphous phase, wherein the amorphous phase contains lithium oxide and tungsten oxide in a form of mixture.

The cathode active material for a lithium secondary battery according to the present invention has a structure in which an amorphous phase containing lithium oxide and tungsten oxide in a form of mixture is present in the coating layer, thereby forming a uniform coating on the surface of the core and remarkably improving the discharge capacity, output characteristics and cycle characteristics of the lithium secondary battery, in particular, the output characteristics at low temperatures thereof.

In a specific embodiment, the lithium composite metal oxide may include one or more transition metals, and may have a layered crystal structure that can be used at high capacity and high voltage, and specifically may be a substance represented by the following Formula 1:

Li[LiₓM_{1-x-y}D_{y}]O₂₋ₐQₐ (1)

wherein M includes at least one transition metal element that is stable in a 4- or 6-coordination structure;

D includes at least one element selected from an alkaline earth metal, a transition metal, and a non-metal as a dopant;

Q includes at least one anion; and

0≤x≤0.1, 0≤y≤0.1, 0≤a≤0.2.

For reference, when D is a transition metal, this transition metal is excluded from the transition metal defined for M.

In a preferred embodiment,

M includes at least two elements selected from the group consisting of Ni, Co, and Mn;

D includes at least one element selected from the group consisting of Al, W, Si, V, B, Ba, Ca, Zr, Ti, Mg, Ta, Nb and Mo; and

Q includes at least one element selected from F, S and P.

In addition, the lithium composite metal oxide may have a crystal structure rather than a layered structure, and examples of such a crystal structure include, but are not limited to, a spinel structure and an olivine structure. The core may have an average particle diameter (D50) of, for example, 1 to 50 μm, but is not limited thereto.

The lithium composite metal oxide forming the core having the composition described above may be prepared by a method known in the art, and thus a description thereof will be omitted herein.

One of the features of the present invention is that the amorphous phase containing lithium oxide and tungsten oxide in a form of mixture is present in the coating layer.

As will be described later, the lithium oxide and tungsten oxide present in the amorphous phase may be adhered to the surface of the core at a low firing temperature for surface treatment of the core, which is a cathode active material. In this process, lithium oxide may act as a coating agent to facilitate the process of adhering the tungsten oxide onto the core.

The coating layer may contain a substance having the composition of the following Formula 2:

XWₓO_{y}—YLi₂O (2)

wherein the conditions X+Y=1 and 0.25≤x/y≤0.5 are satisfied, and X and Y are set on a weight basis.

In a non-limiting example, Formula 2 may be represented by XWO₃—YLi₂O.

Li₂O can improve the meltability or formability of the coating layer by lowering the high-temperature viscosity of glassy oxide. In addition, Li₂O has excellent lithium ion conductivity and does not react with an electrolyte or hydrogen fluoride derived from the electrolyte during charging and discharging. Such Li₂O may be formed by oxidation upon firing of a lithium compound added before firing, may be added as Li₂O itself, or may be derived from a lithium-containing component such as LiOH or Li₂CO₃ present on the surface of the core.

The lithium oxide may be present in the amorphous phase in the coating layer in an amount of 2 parts by weight or less, preferably 0.01 to 2 parts by weight, more preferably 0.1 to 1 part by weight, particularly preferably 0.1 to 0.5 parts by weight based on 100 parts by weight of the lithium composite metal oxide constituting the core. When the content of lithium oxide is excessively low, undesirably, there is a problem in that it is difficult to achieve uniform coating as described above, and when the content is excessively high, undesirably, the lithium oxide is additionally coated on tungsten oxide, which inhibits the coating effect that can be obtained by the tungsten oxide, or the coating is excessively thick, which acts as resistance in the battery.

In a specific embodiment, the tungsten oxide may be WO₃.

The tungsten oxide is present in the amorphous phase in the coating layer, thereby reducing the charge transfer resistance (RCT resistance) of the battery and suppressing agglomeration that occurs when separately present in a crystalline phase.

Meanwhile, lithium oxide such as Li₂O contained along with the tungsten oxide in the amorphous phase provides excellent coating formability and facilitates adhesion of tungsten oxide such as WO₃ to the surface of the core.

The tungsten oxide may be contained in the amorphous phase in the coating layer in an amount of 2 parts by weight or less, preferably 0.1 to 2 parts by weight, more preferably 0.1 to 1.1 parts by weight and particularly preferably 0.1 to 0.5 parts by weight, based on 100 parts by weight of the lithium composite metal oxide constituting the core. When the content of tungsten oxide is excessively low, undesirably, it may be difficult to exhibit the effects described above, and when the content of tungsten oxide is excessively high, undesirably, it does not form a coating, but is separately present outside the core, impeding contact between the cathode active material and the conductive material and the binder when the electrode is formed, acting as a factor that hinders the movement of electrons in the electrode, and preventing desired output characteristics from being achieved.

In a specific embodiment, the thickness of the coating layer may be 0.01 to 1 μm, preferably 0.01 to 0.50 μm. When the thickness of the coating layer is excessively small, undesirably, it may be difficult to expect a desired improvement in the low-temperature characteristics in the present invention, and when the thickness thereof is excessively great, undesirably, the coating layer may act as a factor that hinders the movement of lithium, which may increase the resistance of the battery.

Further, it is preferred that the coating layer be applied on at least 40% of the surface area of the core in order to remarkably improve the desired low-temperature characteristics according to the present invention.

The present invention also provides a method of preparing the cathode active material. Specifically, the preparation method according to the present invention includes mixing a tungsten-containing powder, or a tungsten-containing powder and a lithium-containing powder as a coating raw material with a lithium composite metal oxide powder for a core and firing the resulting mixture in an atmosphere containing oxygen in a temperature range within which an amorphous coating layer is formed.

That is, according to an embodiment of the preparation method of the present invention, core and coating materials for preparing a cathode active material are mixed in the form of powders, rather than a solvent-based mixture such as a slurry, suspension, or solution, followed by firing. As a result, it is possible to prevent a phenomenon in which a crystalline phase is formed by the reaction between the tungsten and lithium components and to achieve effects of improving preparation workability and reducing preparation costs because solvents are not used.

The tungsten-containing powder may be the tungsten oxide (e.g., WO₃) that is itself to be contained in the coating layer, or may in some cases be other tungsten compounds capable of being converted to tungsten oxides through oxidation. Examples of such other tungsten compounds include, but are not limited to, H₂WO₄, (NH₄)₁₀(H₂W₁₂O₄₂).XH₂O, and (NH₄)₆H₂W₁₂O₄₀.XH₂O (wherein X is 1 to 5).

The lithium-containing powder may be the lithium oxide that is itself to be contained in the coating layer, or may be other lithium compounds capable of being converted to lithium oxides through oxidation in some cases. Examples of such lithium compounds include, but are not limited to, LiOH, Li₂CO₃, LiNO₃, Li₂SO₄ and the like.

Here, the lithium oxide of the amorphous coating layer may be derived from a lithium-containing component present on the surface of the lithium composite metal oxide powder. In some cases, the method may include mixing only a tungsten-containing powder with a lithium composite metal oxide powder, followed by firing.

The firing temperature range, within which the amorphous coating layer is formed, may vary slightly depending on the type and content requirements of the raw materials, and may be determined within a range within which the coating raw material does not form a crystal structure and does not diffuse into the core, for example, 150° C. or less, preferably from 150° C. to 500° C., and more preferably from 200° C. to 500° C. When the firing temperature is excessively low, adhesion of the tungsten oxide to the surface of the core may be deteriorated. Conversely, when the firing temperature is excessively high, undesirably, the coating layer is crystallized, and it may be difficult to form a uniform coating layer on the surface of the core.

The firing time may be within the range of about 2 to about 20 hours.

The coating raw material such as tungsten-containing powder preferably has an average particle diameter of about 0.01 to about 5 μm, preferably 0.01 to 1 μm, so that the particles can be uniformly adsorbed on the surface of the core without causing agglomeration therebetween when mixing the core with the coating raw material for the preparation of the cathode active material. The particles are partially or completely melted during the firing process and are transformed into an amorphous phase to form a coating layer having the thickness defined above.

When firing is performed under the conditions described above, a coating layer having an amorphous phase containing lithium oxide and tungsten oxide in a form of mixture is formed, so the coating area and uniformity can be increased and thus scalability can be increased when coating the surface of a core. Accordingly, as described above, the tungsten oxide contained in the amorphous phase can reduce RCT resistance and suppress a phenomenon in which the tungsten oxide is present separately from the core or agglomerates due to crystallization. In addition, the coating uniformity of lithium oxide (for example, Li₂O), which is an ion conductor, can also be increased, and tungsten oxide easily adheres to the surface due to the coating formability of the lithium oxide.

The present invention also provides a lithium secondary battery including the cathode active material. The configuration and production method of the lithium secondary battery are known in the art, and thus a detailed description thereof will be omitted herein.

### Effects of the Invention

As described above, the cathode active material according to the present invention includes a specific coating layer having an amorphous phase on the surface of the core, and is thus capable of suppressing a phenomenon in which a coating material is crystallized and is present separately outside the core, rather than on the surface of the core, and of securing a uniform and large coating area, thereby exerting effects of greatly improving the discharge capacity, output characteristics, and cycle characteristics of the lithium secondary battery, particularly the output characteristics thereof at low temperatures.

### BEST MODE

Now, the present invention will be described in more detail with reference to the following examples. These examples should not be construed as limiting the scope of the present invention.

### Example 11

### (Preparation of Cathode Active Material)

Tungsten oxide (WO₃) was mixed in the amount shown in Table 1 below with 100 parts by weight of lithium composite metal oxide (Li(Ni_{0.60}Co_{0.20}Mn_{0.20})_{0.994}Ti_{0.004}Zr_{0.002}O₂) using a dry mixer, followed by heat treatment in an air atmosphere at the temperature shown in Table 1 below for 7 hours, to prepare a cathode active material having a coating layer (about 0.01 to about 0.1 μm) having an amorphous phase containing the mixture of lithium oxide and tungsten oxide.

It was ascertained that lithium oxide was produced by oxidation of the lithium compound remaining on the surface of the lithium composite metal oxide, the content of the lithium compound remaining on the surface of the lithium composite metal oxide before heat treatment was 0.5 parts by weight when measured by acid/base neutralization titration, and about 0.25 parts by weight of lithium oxide (Li₂O) was formed by oxidation during heat treatment.

### (Production of Cathode)

The cathode active material prepared above, Super-P as a conductive material, and PVdF as a binder were mixed at a weight ratio of 95:2:3 in the presence of N-methylpyrrolidone as a solvent to prepare a cathode active material as a slurry. The cathode active material as a slurry was applied onto an aluminum current collector, dried at 120° C., and then rolled to produce a cathode.

### (Production of Lithium Secondary Battery)

A porous polyethylene film as a separator was interposed between the cathode produced above and an anode as a Li metal to produce an electrode assembly, the electrode assembly was placed in a battery case, and an electrolyte was injected into the battery case to produce a lithium secondary battery. The electrolyte used herein was prepared by dissolving 1.0M lithium hexafluorophosphate (LiPF₆) in an organic solvent consisting of ethylene carbonate/dimethyl carbonate (mixed at a volume ratio of EC/DMC=1/1).

### Example 2

A cathode active material, a cathode, and a lithium secondary battery were produced under the same conditions as in Example 1, except that WO₃ was mixed in an amount of 0.5 parts by weight.

### Example 3

A cathode active material, a cathode, and a lithium secondary battery were produced under the same conditions as in Example 1, except that WO₃ was mixed in an amount of 1.01 parts by weight.

### Example 4

A cathode active material, a cathode, and a lithium secondary battery were produced under the same conditions as in Example 1, except that WO₃ was mixed in an amount of 0.5 parts by weight and the firing temperature was 500° C.

### Example 5

A cathode active material, a cathode, and a lithium secondary battery were produced under the same conditions as in Example 1, except that WO₃ was mixed in an amount of 0.5 parts by weight and the firing temperature was 200° C.

### Example 6

A cathode active material, a cathode, and a lithium secondary battery were produced under the same conditions as in Example 1, except that Li(Ni_{0.35}Co_{0.30}Mn_{0.35})_{0.994}Ti_{0.004}Zr_{0.002}O₂ was prepared as lithium composite metal oxide instead of Li(Ni_{0.60}CO_{0.20}Mn_{0.20})_{0.994}Ti_{0.004}Zr_{0.002}O₂, and WO₃ was mixed in an amount of 0.5 parts by weight.

### Example 7

A cathode active material, a cathode, and a lithium secondary battery were produced under the same conditions as in Example 1, except that Li(Ni_{0.50}Co_{0.20}Mn_{0.30})_{0.994}Ti_{0.004}Zr_{0.002}O₂ was prepared as lithium composite metal oxide instead of Li(Ni_{0.60}CO_{0.20}Mn_{0.20})_{0.994}Ti_{0.004}Zr_{0.002}O₂, and WO₃ was mixed in an amount of 0.5 parts by weight.

### Example 8

A cathode active material, a cathode, and a lithium secondary battery were produced under the same conditions as in Example 1, except that Li(Ni_{0.70}Co_{0.15}Mn_{0.15})_{0.994}Ti_{0.004}Zr_{0.002}O₂ was prepared as lithium composite metal oxide instead of Li(Ni_{0.60}CO_{0.20}Mn_{0.20})_{0.994}Ti_{0.004}Zr_{0.002}O₂, and WO₃ was mixed in an amount of 0.5 parts by weight.

### Example 9

A cathode active material, a cathode, and a lithium secondary battery were produced under the same conditions as in Example 1, except that Li(Ni_{0.82}Co_{0.11}Mn_{0.07})_{0.994}Ti_{0.004}Zr_{0.002}O₂ was prepared as lithium composite metal oxide instead of Li(Ni_{0.60}CO_{0.20}Mn_{0.20})_{0.994}Ti_{0.004}Zr_{0.002}O₂, and WO₃ was mixed in an amount of 0.5 parts by weight.

### Comparative Example 1

A cathode active material, a cathode, and a lithium secondary battery were produced under the same conditions as in Example 1, except that mixing with WO₃ was omitted.

### Comparative Example 2

A cathode active material, a cathode, and a lithium secondary battery were produced under the same conditions as in Example 1, except that WO₃ was mixed in an amount of 0.5 parts by weight and the firing temperature was 700° C.

### Comparative Example 3

A cathode active material, a cathode, and a lithium secondary battery were produced under the same conditions as in Example 1, except that WO₃ was mixed in an amount of 0.5 parts by weight and the firing temperature was 600° C.

### Comparative Example 4

A cathode active material, a cathode, and a lithium secondary battery were produced under the same conditions as in Example 6, except that mixing with WO₃ was omitted.

### Comparative Example 5

A cathode active material, a cathode, and a lithium secondary battery were produced under the same conditions as in Example 7, except that mixing with WO₃ was omitted.

### Comparative Example 6

A cathode active material, a cathode, and a lithium secondary battery were produced under the same conditions as in Example 8, except that mixing with WO₃ was omitted.

### Comparative Example 7

A cathode active material, a cathode, and a lithium secondary battery were produced under the same conditions as in Example 9, except that mixing with WO₃ was omitted.

TABLE 1

| | Core | WO₃ | Heat treatment |
|---|---|---|---|
| | composition | (parts by | temperature |
| Item | (Ni:Co:Mn) | weight) | (° C.) |
| Example 1 | 60:20:20 | 0.25 | 400 |
| Example 2 | 60:20:20 | 0.5 | 400 |
| Example 3 | 60:20:20 | 1.01 | 400 |
| Example 4 | 60:20:20 | 0.5 | 500 |
| Example 5 | 60:20:20 | 0.5 | 200 |
| Comparative Example 1 | 60:20:20 | — | — |
| Comparative Example 2 | 60:20:20 | 0.5 | 700 |
| Comparative Example 3 | 60:20:20 | 0.5 | 600 |
| Example 6 | 35:30:35 | 0.5 | 400 |
| Comparative Example 4 | 35:30:35 | — | — |
| Example 7 | 50:20:30 | 0.5 | 400 |
| Comparative Example 5 | 50:20:30 | — | — |
| Example 8 | 70:15:15 | 0.5 | 400 |
| Comparative Example 6 | 70:15:15 | — | — |
| Example 9 | 82:11:07 | 0.5 | 400 |
| Comparative Example 7 | 82:11:07 | — | — |

### Experimental Example

Each of the lithium secondary batteries produced in Examples 1 to 9 and Comparative Examples 1 to 7 was subjected to 0.1C charge and 0.1C discharge twice at room temperature for electrode stabilization, followed by 0.2C charge and 0.2C discharge twice and then 0.2C charge and 2.0C discharge once at −25° C. for evaluation of low-temperature output characteristics. The results are shown in Table 2 below. In addition, to evaluate the cycle characteristics, the lithium secondary battery was subjected to 0.1C charge and 0.1C discharge 50 times at room temperature, and the results are shown in Table 3 below.

TABLE 2

| | | | | | | | Rate |
|---|---|---|---|---|---|---|---|
| | 0.2/0.2 C (2^{nd}) | | | 0.2/2.0 C | | | retention |
| | CC | DC | Eff. | CC | DC | Eff. | 2.0 C |
| Item | mAh/g | mAh/g | % | mAh/g | mAh/g | % | % |
| Example 1 | 152.9 | 152.4 | 99.7 | 117.4 | 106.2 | 90.5 | 69.7 |
| Example 2 | 153.0 | 152.7 | 99.8 | 117.9 | 107.1 | 90.8 | 70.1 |
| Example 3 | 152.2 | 151.3 | 99.4 | 116.2 | 104.8 | 90.2 | 69.3 |
| Example 4 | 153.1 | 152.4 | 99.5 | 117.3 | 106.1 | 90.5 | 66.1 |
| Example 5 | 152.0 | 151.3 | 99.5 | 115.5 | 104.2 | 90.2 | 67.1 |
| Comparative | 153.2 | 149.0 | 97.3 | 117.9 | 98.9 | 83.9 | 65.2 |
| Example 1 | | | | | | | |
| Comparative | 152.3 | 151.1 | 99.2 | 117.0 | 99.4 | 85.0 | 65.8 |
| Example 2 | | | | | | | |
| Comparative | 152.6 | 151.5 | 99.3 | 117.3 | 100.1 | 85.3 | 66.1 |
| Example 3 | | | | | | | |
| Example 6 | 131.8 | 131.5 | 99.8 | 101.7 | 92.2 | 90.7 | 70.1 |
| Comparative | 131.4 | 129.7 | 98.7 | 95.9 | 83.0 | 86.5 | 64.0 |
| Example 4 | | | | | | | |
| Example 7 | 142.6 | 142.0 | 99.6 | 109.7 | 99.3 | 90.5 | 69.9 |
| Comparative | 141.9 | 139.6 | 98.4 | 105.9 | 89.2 | 84.2 | 63.9 |
| Example 5 | | | | | | | |
| Example 8 | 164.5 | 164.0 | 99.7 | 127.0 | 114.8 | 90.4 | 70.0 |
| Comparative | 162.8 | 159.5 | 98.0 | 122.9 | 103.1 | 83.9 | 64.6 |
| Example 6 | | | | | | | |
| Example 9 | 181.5 | 181.0 | 99.7 | 139.7 | 126.3 | 90.4 | 69.8 |
| Comparative | 179.3 | 176.6 | 98.5 | 134.0 | 113.4 | 84.6 | 64.2 |
| Example 7 | | | | | | | |

TABLE 3

| | Cycle, 25° C. | | | | | | |
|---|---|---|---|---|---|---|---|
| | 1CY | 30CY | 40CY | 50CY | 30/1 | 40/1 | 50/1 |
| Item | mAh/g | | | | % | | |
| Example 1 | 172.4 | 167.5 | 165.8 | 163.6 | 97.2 | 96.2 | 94.9 |
| Example 2 | 173.2 | 168.5 | 167.2 | 165.4 | 97.3 | 96.5 | 95.5 |
| Example 3 | 171.7 | 166.9 | 165.9 | 163.2 | 97.2 | 96.6 | 95.0 |
| Example 4 | 171.5 | 167.9 | 165.7 | 162.8 | 97.9 | 96.6 | 94.9 |
| Example 5 | 170.1 | 165.1 | 162.4 | 160.1 | 97.1 | 95.5 | 94.1 |
| Comparative | 168.7 | 161.4 | 158.3 | 150.4 | 95.7 | 93.8 | 89.2 |
| Example 1 | | | | | | | |
| Comparative | 170.6 | 160.4 | 154.1 | 151.7 | 94.0 | 90.3 | 88.9 |
| Example 2 | | | | | | | |
| Comparative | 171.5 | 165.9 | 160.7 | 156.8 | 96.7 | 93.7 | 91.4 |
| Example 3 | | | | | | | |
| Example 6 | 149.4 | 147.9 | 145.4 | 143.9 | 99.0 | 97.3 | 96.3 |
| Comparative | 147.7 | 144.5 | 140.0 | 134.0 | 97.8 | 94.8 | 90.7 |
| Example 4 | | | | | | | |
| Example 7 | 156.9 | 153.2 | 151.3 | 148.7 | 97.6 | 96.4 | 94.8 |
| Comparative | 153.5 | 147.9 | 144.7 | 138.0 | 96.4 | 94.3 | 89.9 |
| Example 5 | | | | | | | |
| Example 8 | 179.9 | 174.4 | 171.3 | 168.9 | 96.9 | 95.2 | 93.9 |
| Comparative | 175.8 | 167.5 | 162.0 | 154.5 | 95.3 | 92.2 | 87.9 |
| Example 6 | | | | | | | |
| Example 9 | 198.6 | 191.2 | 187.1 | 184.6 | 96.3 | 94.2 | 93.0 |
| Comparative | 194.4 | 183.0 | 177.8 | 168.0 | 94.1 | 91.5 | 86.4 |
| Example 7 | | | | | | | |

As can be seen from Tables 2 and 3, the lithium secondary batteries of Examples 1 to 9 according to the present invention have high discharge capacity and high discharge efficiency and exhibit remarkably excellent output characteristics at low temperatures, in particular, excellent output characteristics under high-rate discharge conditions (2.0C discharge) and excellent cycle characteristics, compared to the lithium secondary batteries of Comparative Examples 1 to 7.

The reason for this is that, in Examples 1 to 9 according to the present invention, because the cathode active material is fired at a relatively low temperature, a coating layer having an amorphous phase is uniformly formed on the surface of the core, the movement of lithium ions is facilitated, and electrical conductivity (lithium ion conductor) is improved, whereas in Comparative Examples 1 to 7, a crystalline coating layer is formed on the surface of the core because firing is performed at a higher temperature than in Examples of the present invention.

Although preferred embodiments of the present invention have been disclosed for illustrative purposes, those skilled in the art will appreciate that various modifications, additions and substitutions are possible, without departing from the scope and spirit of the invention as disclosed in the accompanying claims.

1. A cathode active material for a lithium secondary battery comprising:
a core containing lithium composite metal oxide; and
a coating layer disposed on the core and having an amorphous phase,
wherein the amorphous phase comprises lithium oxide and tungsten oxide in a form of mixture.

2. The cathode active material according to claim 1, wherein the coating layer comprises a substance having the composition represented by the following Formula 2:
XWₓO_{y}—YLi₂O (2)
wherein X+Y=1 and 0.25≤x/y≤0.5 are satisfied.

3. The cathode active material according to claim 2, wherein the coating layer comprises a substance having the composition represented by the following Formula 3:
XWO₃—YLi₂O (3)
wherein X+Y=1 is satisfied.

4. The cathode active material according to claim 1, wherein the core has an average particle diameter of 1 to 50 μm.

5. The cathode active material according to claim 1, wherein the lithium oxide and the tungsten oxide in the amorphous phase are present in amounts of 0.01 to 2 parts by weight and 0.1 to 2 parts by weight, respectively, based on 100 parts by weight of the core.

6. The cathode active material according to claim 1, wherein the coating layer has a thickness of 0.01 to 1 μm.

7. The cathode active material according to claim 1, wherein the coating layer is coated on 40 to 100% of a surface area of the core.

8. A method of preparing the cathode active material according to claim 1, the method comprising:
mixing a tungsten-containing powder, or a tungsten-containing powder and a lithium-containing powder, with a lithium composite metal oxide powder for a core, followed by firing in an atmosphere containing oxygen in a temperature range within which an amorphous coating layer is formed.

9. The method according to claim 8, wherein the method comprises mixing the tungsten-containing powder with the lithium composite metal oxide powder, followed by firing, and the lithium oxide of the amorphous coating layer is derived from a lithium-containing component present on the surface of the lithium composite metal oxide powder.

10. The method according to claim 8, wherein the temperature range is 500° C. or less.

11. The method according to claim 10, wherein the temperature range is 200 to 500° C.

12. A lithium secondary battery comprising the cathode active material according to claim 1.
